(19) United States
(12) Patent Application Publication
(10) Pub. No.: US 2002/0028171 A1
(43) Pub. Date: Mar. 7, 2002

(54) Production of hydrogen by autothermic decomposition of ammonia

(76) Inventors: Duane A. Goetsch, Andover, MN (US); Steve J. Schmit, Plymouth, MN (US)

Correspondence Address: Henry E. Naylor & Associates, LLC, 11750A S. Harrell's Ferry Rd, Baton Rouge, LA, 70816, US

(21) Appl. No.: 09/853,434

(22) Filed: May 10, 2001

Related U.S. Application Data
(60) Provisional application No. 60/203,542, filed on May 12, 2000.

(51) Int. Cl. C01B 3/04; H01M 8/06; C01B 3/06

(52) U.S. Cl. 423/237; 423/351; 423/648.1; 429/17; 423/658.2

(57) ABSTRACT

This invention relates to the autothermal decomposition of ammonia to produce high purity hydrogen. This invention also relates to a fuel cell system wherein hydrogen that is produced from the autothermic decomposition of ammonia is used as fuel to a fuel cell.

### CROSS-REFERENCE TO RELATED APPLICATIONS

This application is based on Provisional Application 60/203,542 filed May 10, 2000.

### BACKGROUND

This invention relates to the autothermal decomposition of ammonia to produce high purity hydrogen. This invention also relates to a fuel cell system wherein hydrogen that is produced from the autothermic decomposition of ammonia is used as fuel to a fuel cell.

Hydrogen is needed in various industries for a variety of processes. For example, the petroleum industry uses large quantities of hydrogen for processes such as hydrogenation, hydrocracking, hydrotreating, and hydroisomerization. There is also an emerging need in the fuel cell industry for hydrogen, especially for on-board hydrogen production units that can feed hydrogen to a fuel cell. Hydrogen is the most commonly utilized fuel for fuel cells and reacts therein with oxygen introduced to the cell to yield water as a reaction by-product.

As is well known in the art, fuel cells generate electric current by the reaction of a fuel and oxidant brought into contact with a suitable electrolyte. Current is generated by a catalyzed chemical reaction on electrode surfaces that are maintained in contact with the electrolyte. Known types of fuel cells include a bipolar, phosphoric acid electrolyte cell that utilizes hydrogen as the fuel and the oxygen in air as the oxidant. One such phosphoric acid electrolyte cell utilizes a matrix type construction with bipolar stacking of hydrophobic electrodes, a concentrated phosphoric acid electrolyte and one or more platinum group metals as the electrode catalyst. Air, or air with a circulating coolant, may be used for heat and water removal from the cell, which is capable of utilizing impure hydrogen as the fuel. Other types of fuel cells that can use hydrogen as the fuel are of course known, utilizing various cell constructions and various electrolytes such as aqueous potassium hydroxide, fused alkali carbonate, solid polymer electrolytes, etc. A variety of electrode catalysts, such as nickel, silver, base metal oxides and tungsten carbide are known as electrode catalysts.

Fuel cells offer the possibility of significant advantages over other electrical power sources, including low operating costs, modular construction that enables “tailor-made” sizing and siting of the units, and protection of the environment in view of the lack of significant noxious exhaust.

Hydrogen can be produced from various processes. One such process is the decomposition, or cracking, of ammonia to produce nitrogen and hydrogen. Commercial ammonia decomposition by conventional methods is generally not practiced since traditional large-scale sources of hydrogen are available. For example, hydrogen is obtained in a petroleum refinery as a waste stream from catalytic naphtha reforming. It is also produced from the partial oxidation of heavy hydrocarbons, such as fuel oil, or from steam reforming of so-called light ends, such as methane, ethane, or propane. While such processes are preferred for large-scale production of hydrogen where it can be stored in vessels on a refinery site, they typically cannot be used for the on-board generation of hydrogen for feed to fuel cells.

Steam reforming is a well known method for generating hydrogen from light hydrocarbon feeds and is carried out by supplying heat to a mixture of steam and a hydrocarbon feed while contacting the mixture with a suitable catalyst, usually nickel. However, steam reforming is generally limited to paraffinic naphtha and lighter feeds that have been de-sulfurized and treated to remove nitrogen compounds. This is because of difficulties in attempting to steam reform heavier hydrocarbons and the poisoning of steam reforming catalysts by sulfur and nitrogen compounds.

Another known method of obtaining hydrogen from a hydrocarbon feed is the partial oxidation process in which the feed is introduced into an oxidation zone maintained in a fuel rich mode so that only a portion of the feed is oxidized. Steam may be injected into the partial oxidation reactor vessel to react with the feed and with products of the partial oxidation reaction. The process is not catalytic and requires high temperatures to carry the reactions to completion, resulting in relatively high oxygen consumption.

Catalytic autothermal reforming of hydrocarbon liquids is also known in the art. Autothermal reforming is typically defined as the utilization of catalytic partial oxidation in the presence of added steam, which is said to increase the hydrogen yield because of simultaneous (with the catalytic partial oxidation) steam reforming being attained. Steam, air and a No. 2 fuel oil are injected through three different nickel particulate catalysts. The resulting product gases contain hydrogen and carbon oxides.

U.S. Pat. No. 4,054,407 discloses two-stage catalytic oxidation using platinum group metal catalytic components dispersed on a monolithic body. At least a stoichiometric amount of air is supplied over the two stages in the absence of steam.

U.S. Pat. No. 3,481,722 discloses a two-stage process for steam reforming normally liquid hydrocarbons using a platinum group metal catalyst in the first stage. Steam and hydrogen, the latter of which may be obtained by partially cracking the hydrocarbon feed, are combined with the feed to the process.

The use of autothermal reforming as part of an integral fuel cell power plant to generate a hydrogen fuel from a hydrocarbon feed to supply a fuel cell is shown in U.S. Pat. No. 3,976,507 issued Aug. 24, 1976 to D. P. Bloomfield. An autothermal reactor converts a hydrocarbon feed to supply a hydrogen-rich fuel to the anode gas space. The plant includes a compressor driven by exhaust gases from a catalytic burner to compress air supplied to the cathode gas space of a fuel cell stack. The cathode vent gas from the fuel cell is fed to the autothermal reactor and the anode vent gas is fed to the catalytic burner.

A significant factor for the commercialization of fuel cells is the availability of a reliable and suitable source of hydrogen fuel. For example, as described above, hydrogen can be prepared from hydrocarbons by the partial oxidation of heavier hydrocarbons, such as fuel oil and coal, and by steam reforming of lighter hydrocarbons such as natural gas and naphthas. Processes to derive hydrogen from methanol or coal-derived hydrocarbons are also known. Generally, difficulties associated with the preparation of hydrogen from heavier feedstocks tend to favor the use of light naphthas or natural gas as the hydrocarbon source. However, most fuel cells are sensitive to hydrocarbons in the hydrogen fuel. Therefore, there is a need in the art for sources of hydrogen for feed to a fuel cell without hydrocarbon contamination and other disadvantages found in the art.

### SUMMARY OF THE INVENTION

In accordance with the present invention there is provided an autothermal process for the decomposition of ammonia, which process comprises:

feeding ammonia and air into a reaction zone where it is contacted with an ammonia decomposition catalyst under conditions to cause the ammonia to decompose into nitrogen and hydrogen by an endothermic reaction, wherein a portion of the hydrogen thus produced is combusted in said reaction zone by an exothermic reaction, thus producing enough heat in-situ to run the ammonia decomposition reaction.

In a preferred embodiment of the present invention additional hydrogen is introduced into said reaction zone.

Also in accordance with the present invention there is provided a method for operating a hydrogen fuel cell having an ammonia storage vessel coupled with an ammonia reforming reactor, said ammonia reforming reactor being coupled with said hydrogen fuel cell, said method comprising:

passing said ammonia from said ammonia storage vessel into said ammonia reforming reactor containing ammonia decomposition catalyst and subjecting said ammonia to conditions under which said ammonia undergoes decomposition to nitrogen and hydrogen and wherein a first portion of said hydrogen is combusted in said reaction zone to drive the ammonia decomposition reaction;

passing said second portion of hydrogen to said hydrogen fuel cell;

reacting said hydrogen in said hydrogen fuel cell to produce electric current; and

using said electric current to run.

### BRIEF DESCRIPTION OF THE DRAWINGS

FIG. 1 is a representation of a directly coupled ammonia decomposition reactor configuration shown with a monolith catalyst support system.

FIG. 2 is a representation of an indirectly coupled ammonia decomposition reactor configuration shown with monolith catalyst support systems.

FIG. 3 is a representation of an indirectly coupled ammonia decomposition reactor configuration shown with ceramic fiber mat catalyst support systems.

FIG. 4 is a cross-sectional representation of a coaxial two-pass reactor configuration utilizing a monolithic catalyst bed.

### DETAILED DESCRIPTION

The present process relates to the use of an ammonia decomposition catalyst, preferably a heterogeneous transition metal catalyst in a gas-solid chemical reactor to catalyze the decomposition of ammonia to product hydrogen and nitrogen. The ammonia decomposition reaction is an endothermic reaction and thus cannot sustain itself without the addition of heat. It has been discovered by the inventors hereof that the ammonia decomposition reaction can be made autothermic, that is, without the need for added heat from an outside source. Autothermal operation occurs when an exothermic reaction continues to drive itself as well as a coupled endothermic reaction. This is accomplished by combusting a portion of the product hydrogen in the same reaction zone in which ammonia decomposition is taking place. For each mole of ammonia that is completely oxidized, enough heat is generated to decompose approximately 5.7 moles of ammonia.

The exothermic combustion of hydrogen generates relatively large amounts of heat that can subsequently drive the endothermic ammonia decomposition reaction. Thus, by the practice of the present invention the exothermic combustion of hydrogen is coupled with the endothermic ammonia decomposition reaction. Conducting the ammonia decomposition reaction under such autothermic conditions leads to higher conversions of ammonia and to higher hydrogen selectivities. There is an advantage to thermally integrating the reactor so that as much heat as possible stays in the reactor i.e. bed temperatures are higher and less hydrogen needs to be consumed—this aids in increasing hydrogen selectivity. An autothermic state is achieved in which no heat need be added to the reaction system. Performance can further be enhanced through the independent supply of heat to the reaction system or recovery and reuse of heat generated within the reactor.

Any catalyst can be used that is capable of decomposing ammonia to produce a hydrogen and nitrogen. Preferred catalysts include the transition metals, such as those selected from the group consisting of Groups IIIA (Sc, Y, La), IVA (Ti, Zr, Hf), VA (V, Nb, Ta), VIA (Cr, Mo, W), VIIA (Mn, Re), VIIIA (Fe, Co, Ni, etc.), IB (Cu, Ag, Au), and IIB (Zn, Cd, Hg) of the Periodic Table of the Elements, inclusive of mixtures and alloys thereof. Preferred are the metals from Groups VIA, VIIA, and VIIIA, particularly Fe, Ni, Co, Cr, Mn, Pt, Pd, and Ru. Also included as suitable ammonia decomposition catalysts are those disclosed in U.S. Pat. No. 5,976,723, which is incorporated herein by reference. The catalysts of U.S. Pat. No. 5,976,723 are comprised of: a) alloys having the general formula Zr₁₋ₓTiₓM₁M₂ wherein M₁ and M₂ are selected independently from the group consisting of chromium, manganese, iron, cobalt, and nickel and x is in the range from about 0.0 to 1.0 inclusive, and b) between about 20% by weight and about 50 by weight of aluminum.

The ammonia decomposition catalysts used in the practice of the present invention may be both supported and non-supported. A preferred non-supported catalyst would be a pure metallic woven mesh, more preferably a nickel woven mesh. It is also preferred that the catalysts be supported on any suitable support. Preferred support structures include monoliths, fiber mats, and particles. The supports will preferably be comprised of carbon or a metal oxide, such as alumina, silica, silica-alumina, titania, magnesia, aluminum metasilicates, and the like. The most preferred supports are comprised of alumina, and the preferred support structure in a monolith. Monoliths are preferred because they allow for relatively high gas flow rates since they contain a plurality of finely divided gas flow passages extending there-through. Such monolithic structures are often referred to as “honeycomb” type structures and are well known in the art. A preferred form of such a structure is made of a refractory, substantially inert rigid material that is capable of maintaining its shape and has a sufficient degree of mechanical strength at high temperatures, for example, up to about 1,800° C. Typically, a material is selected for the monolith that exhibits a low thermal coefficient of expansion, good thermal shock resistance and, though not always, low thermal conductivity. There are two general types of material of construction for such structures. One is a ceramic-like porous material comprised of one or more metal oxides, for example, alumina, alumina-silica, alumina-silica-titania, mullite, cordierite, zirconia, zirconia-spinel, zirconia-mullite, silicon carbide, etc. A particularly preferred and commercially available material of construction for operations below about 1100° C. is cordierite, which is an alumina-magnesia-silica material. For applications involving operations above about 1100° C., an alumina-silica-titania material is preferred. Honeycomb monolithic supports are commercially available in various sizes and configurations. Typically, the monolithic support will comprise, e.g., a cordierite member of generally cylindrical configuration (either round or oval in cross section) and having a plurality of parallel gas flow passages of regular polygonal cross sectional extending there-through. The gas flow passages are typically sized to provide from about 50 to 1,200, more typically from about 200 to 600 gas flow channels per square inch of face area.

The second type of preferred material for the catalyst support structures used herein are the heat- and oxidation-resistant metals, such as stainless steel or the like. Also suitable are materials known as Fecralloys that can withstand high temperatures, can be washcoated, and can also form an alumina layer (oxide layer) on its surface that can be used to not only support a metal catalyst but that also can act as a thermal insulating material). Monolithic supports are typically made from such materials by placing a flat and corrugated metal sheet one over the other and rolling the stacked sheets into a tubular configuration about an axis parallel to the corrugations. This provides a cylindrical-shaped body having a plurality of fine, substantially parallel gas flow passages extending there-through. The sheets and corrugations are sized to provide the desired number of gas flow passages, which may range, typically from about 200 to 1,200 per square inch of end face area of the tubular roll.

Although the ceramic-like metal oxide materials, such as cordierite or alumina-silica-titania are somewhat porous and rough-textured, they nonetheless have a relatively low surface area with respect to catalyst support requirements and, of course, a stainless steel or other metal support is essentially smooth and substantially non-porous. Accordingly, a suitable high surface area refractory metal oxide support layer can be deposited on the carrier to serve as a support upon which finely dispersed catalytic metal may be distended. As is generally known in the art, oxides of one or more of the metals of Groups II, III, and IV of the Periodic Table of Elements having atomic numbers not greater than about 40 are satisfactory as the support layer. Non-limiting examples of preferred high surface area support coatings are alumina, beryllia, zirconia, baria-alumina, magnesia, silica, and combinations of two or more of the foregoing.

The most preferred support coating is alumina, most preferably a stabilized, high-surface area transition alumina. As used herein and in the claims, “transition alumina” includes gamma, chi, eta, kappa, theta and delta forms and mixtures thereof. An alumina comprising or predominating in gamma alumina is the most preferred support layer. It is known that certain additives such as, e.g., one or more rare earth metal oxides and/or alkaline earth metal oxides may be included in the transition alumina (usually in amounts comprising from 2 to 10 weight percent of the stabilized coating) to stabilize it against the generally undesirable high temperature phase transition to alpha alumina, which is a relatively low surface area. For example, oxides of one or more of lanthanum, cerium, praseodymium, calcium, barium, strontium and magnesium may be used as a stabilizer. The specific combination of oxides of lanthanum and barium is a preferred stabilizer for transition alumina.

The catalyst can also be added to the monolith in a paint-like liquid containing the catalyst, which is coated on the channel walls. There are several conventional methods for adding the catalyst by use of the paint-like liquid. For example, the monoliths can be sprayed with a non-viscous solution containing the dissolved catalyst. The monoliths can also be coated by dipping them into a catalyst-enriched slurry, then blowing out the slurry with air. The air clears the channels leaving a layer of deposited slurry solids on the channel walls. A solid coat of catalyst, called wash-coat, is left after the liquid component dries out. A third method is to suck the slurry through the monolith by lowering one end of the monolith into a catalyst-slurry and applying a vacuum at the other end of the monolith.

The present invention allows for the production of enriched hydrogen gas streams through the decomposition of ammonia in chemical reactors that operate at contact times shorter than traditional hydrogen generating techniques. Thus, the present invention offers two primary advantages. First, ammonia is used as the feedstock and second, short contact times allow the use of smaller reactors. The hydrogen generated by this process can be used in any process that requires it. Since the major products of this process are hydrogen, nitrogen, and water, the product stream of this invention is especially suited for use in fuel cell technology.

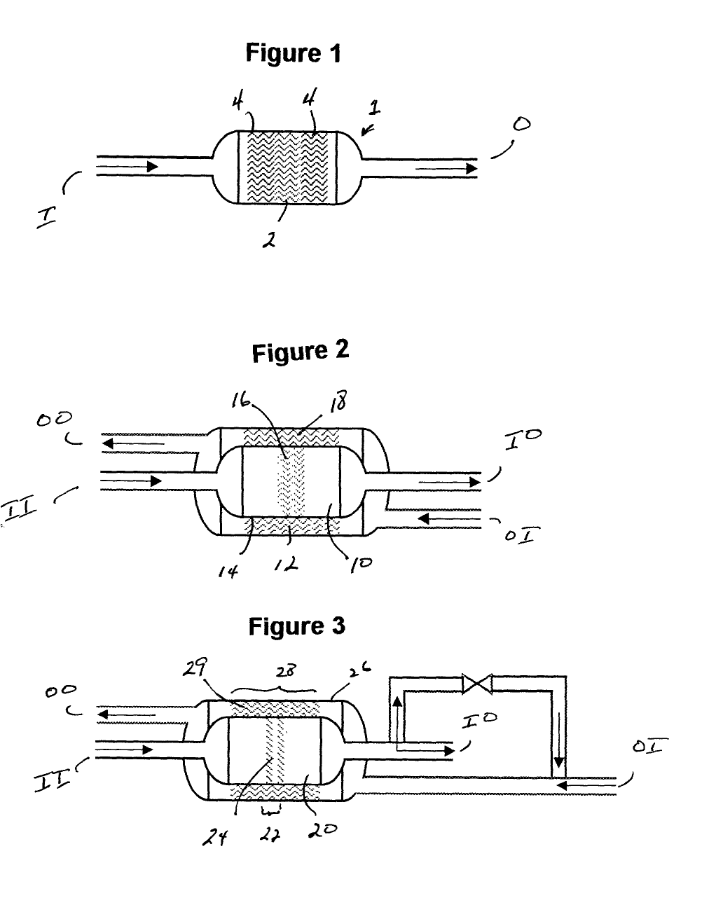

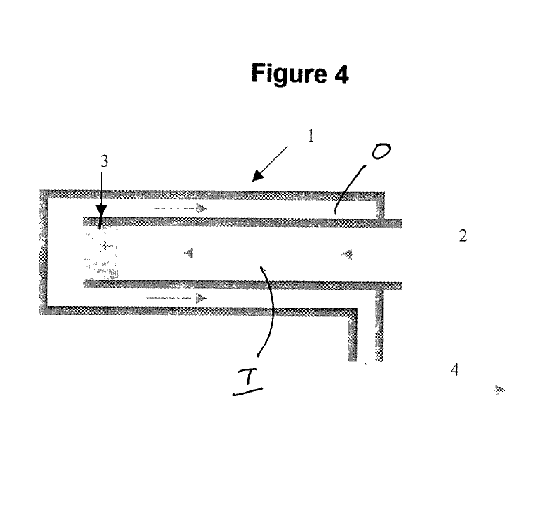

Several types of ammonia decomposition reactors can be used in the practice of the present invention. The reactor can be either a “directly coupled reactor” or an “indirectly coupled reactor”. In the directly coupled reactor the exothermic hydrogen/ammonia combustion reaction is coupled to the endothermic decomposition reaction in a single reaction chamber, such as that illustrated in FIG. 1 hereof. In the indirectly coupled reactor the exothermic hydrogen/ammonia combustion reaction is coupled to the endothermic decomposition reaction in two reaction chambers separated by a wall as illustrated in FIGS. 3 and 4 hereof.

Reference is made to FIG. 1 hereof which shows reactor 1 containing therein a suitable catalyst support structure 2, such as a monolith or ceramic fiber mat 2. On either side of the catalyst support structure are blank support structures 4 that do not contain catalyst and that serve as radiation shields to reduce heat loss, thus enhancing autothermal adiabatic operation. It is to be understood that one or more different support structures can be used in the same reactor. For example, the catalyst support structure can be either a monolith or a ceramic fiber mat and one or both of the blanks can independently be a monolith or ceramic fiber mat. It is also within the scope of the present invention that the reaction zone contains a bed of conventional ammonia decomposition catalysts supported on metal oxide support particles, such as alumina. In fact, a bed of such conventional catalyst particles can be sandwiched between the blanks 4.

A feedstock comprised of ammonia and air, or ammonia, air and hydrogen, enters the reactor at input I where it reacts with the ammonia decomposition catalyst on the monolith catalyst support structures 2 at suitable temperatures. Suitable temperatures are those in the range of about 500° C. to about 1200° C., preferably from about 700° C. to about 1000° C. Of course the temperature used will depend on such things as feed composition, catalyst, etc. Flow rates suitable for use with directly coupled reactors of the present invention will range from about 30,000 hr⁻¹ to about 1,000,000 hr⁻¹, preferably from about 50,000 hr⁻¹ to about 900,000 hr⁻¹. These flow rates are in terms of gas hourly space velocities (GHSV) which is typically a measurement of standard volumetric flow rate of feed gas divided by catalyst bed volume. The decomposition of ammonia, which is an endothermic reaction, produces nitrogen and hydrogen as product gases. A fraction of hydrogen is allowed to combust in the reaction zone. The combustion of hydrogen, which is an exothermic reaction, produces enough heat to drive both the combustion of hydrogen as well as to drive the endothermic ammonia decomposition reaction. Thus, the ammonia decomposition reaction, as practiced in accordance with the present invention, is an autothermic reaction. It is to be understood that ammonia oxidation also takes place during hydrogen combustion, which also contributes heat for the autothermic reaction. Reaction products exit the reactor at outlet O. The reaction products include hydrogen, nitrogen, water, and ammonia. It is preferred that the ammonia be removed from the product stream by any suitable conventional technique, such as by passing the product stream through a suitable molecule sieve that is selective for absorbing ammonia, or by the use of a water trap that will absorb the ammonia. The remaining hydrogen/nitrogen stream can now be collected or passed to any suitable devise that uses hydrogen as a fuel. Although the hydrogen can be separated from the nitrogen if desired, it will usually not be necessary because the amount of nitrogen in the product stream will generally not have a serious adverse affect on the fuel value of the stream.

FIG. 2 hereof is a representation of an indirectly coupled reactor having an inner reaction chamber 10 and an outer reaction chamber 12 separated by wall 14 of inner reaction chamber 10. Inner reaction chamber 10 contains a catalyst support structure 16 that may also have support structure blanks (not shown) at one or both of its ends to prevent heat loss. Outer reaction chamber also contains a catalyst support structure 18 that may also contain support structure blanks at one or both of its ends. The support structures are as described for FIG. 1 above. In practice, an ammonia/air feedstream will enter inner reaction chamber inlet II and decompose when contacted with the catalyst on catalyst support structure 16. The resulting product stream exits at inner reaction chamber outlet IO and will be comprised of hydrogen, nitrogen, and small amounts of breakthrough ammonia. The ammonia can be removed by conventional techniques as previously discussed. The ammonia decomposition reaction is endothermic and needs a substantial amount of heat input to drive it autothermically. This substantial amount of heat, for purposes of this figure, is obtained by reacting a portion of the hydrogen stream in outer reaction chamber 18. The hydrogen stream, that can also contain the nitrogen reaction product, enters outer reaction chamber at inlet OI and combusts in the presence of oxygen. The oxygen may merely come from air or added oxygen may be injected into the reactor (not shown). It is also within the scope of this invention that pure oxygen be used. The hydrogen combustion reaction zone can also contain a catalyst on a support structure 18 where it is combusted to primarily water. The hydrogen combustion reaction is highly exothermic and thus enough heat is generated to drive both the hydrogen combustion reaction taking place in outer reaction chamber 12 as well as the ammonia decomposition reaction taking place in inner reaction chamber 10. It is to be understood that hydrogen can be added by an outside source in all of the process scenarios discussed herein. Also, there will be excess hydrogen in the case where the autothermal ammonia decomposition process of the present invention is coupled with a fuel cell. That is, the ammonia decomposition reaction will produce hydrogen at a faster rate than is needed by the fuel cell. Instead of venting the excess hydrogen to the atmosphere it is preferred to use it in the hydrogen combustion reactor (outer chamber) to produce additional heat that may be needed to autothermally drive the ammonia decomposition reaction (inner chamber). Some of this excess hydrogen may also be stored in a storage vessel.

The wall of the inner chamber is comprised of a material and of a thickness that will allow for sufficient heat transfer from the outer chamber to the inner chamber to drive the endothermic ammonia decomposition reaction. One advantage of an indirectly coupled reactor configuration is that the ammonia:oxygen ratio in the feedstream to each chamber can be separately varied so that ammonia combustion primarily occurs in the outer chamber whereas ammonia decomposition occurs in the inner chamber. Preferred ammonia to oxygen ratios will range from about 3 to about 15 more preferably from about 5 to about 10. Heat transfer from the extremely hot outer chamber to the inner chamber drives the endothermic decomposition in the inner chamber. As a result, the reactions are coupled and can occur autothermally.

FIG. 3 hereof shows another configuration for an indirectly coupled reactor that can be used in the practice of the present invention. The reactor of FIG. 3 shows an inner reactor 20 having an inner reaction zone 22 defined by catalyst on a catalyst support structure 24. There is also provided an outer reactor 26 containing an outer reaction zone 28 defined by catalyst on a suitable catalyst support structure 29. The support structures are as previously described. A feedstream of ammonia and air, or ammonia, air and hydrogen enters inner reactor at inner reactor inlet II and is reacted with the ammonia decomposition catalyst on the catalyst support structure 24. Product gases exit inner reactor at outlet IO where at least a side-stream of hydrogen-containing product gas is drawn-off and conducted to outer reactor inlet OI where it is blended with an ammonia/air mixture being fed into outer inlet OI. It is passed to reaction zone 28 where it is combusted in a highly exothermic reaction that provides heat for the ammonia decomposition reaction occurring in the inner reactor. Product gases that consist primarily of steam exit the outer reactor at OO. The advantage of the configuration of the reactor of this FIG. 3 is that the ammonia combustion reaction can be readily enhanced with the addition of hydrogen to the feedstream to the outer reactor. The source of hydrogen can be a fraction of the product hydrogen from the inner reactor where ammonia decomposition occurs.

FIG. 4 hereof is a cross-sectional view, along the longitudinal axis, of coaxial two-pass reactor configuration. This reactor is a thermal integration reactor in which reactor efficiency is boosted via preheat of the feed as it is conducted through inner chamber I by the hot reactor effluent passing out of the reactor through outer chamber O. A feedstream of ammonia and an oxygen-containing gas, preferably air, are fed via line 2 through inner chamber I of reactor 1 and through catalyst bed 3 where ammonia is decomposed and an effluent stream comprised of hydrogen, nitrogen, and water vapor is formed. It is preferred that the catalyst bed be a catalyst-containing monolith. Effluent gases pass through outer chamber O, give up heat to inner chamber I and exit the reactor at 4.

As previously mentioned, the hydrogen produced by the practice of the present invention can by used for any downstream use, such as a fuel cell, an internal combustion engine, or in refinery processes requiring hydrogen such as hydrocracking, hydrotreating, and hydroisomerization. It is preferred that the process of the present invention for autothermally decomposing ammonia to produce hydrogen be coupled with a fuel cell, preferably an on-board fuel cell for providing energy to drive a transportation vehicle. Any fuel cell that utilizes hydrogen as a fuel can be used in the practice of the present invention. Fuel cells show promise as potential replacements for internal combustion engines in transportation applications, and have already been used to power sources in spacecraft. They operate more efficiently than internal combustion engines and they could have a major impact on improving the air quality in urban areas by virtually eliminating particulates, NOₓ, and sulfur oxide emissions, and significantly reducing hydrocarbon and CO emissions.

Electricity is generated from the fuel cell that preferably comprises a stack of anodes and cathodes and having an anode side and a cathode side. Each side is dimensioned and configured for the passage of respective gas streams there-through, the fuel cell being fueled by a hydrogen-rich gas derived by the decomposition of ammonia as herein The hydrogen-containing gas will be fed to the anode side of the fuel cell and an air stream will be introduced to the cathode side of the fuel cell wherein the fuel cell is operated to generate output electricity, a hydrogen-containing anode vent gas, and a cathode vent gas.

The results for ammonia decomposition carried out in a reactor configuration shown in FIG. 1 hereof are summarized in Tables 1 through 6 hereof. The data presented in Table 1 below show the result for iron supported on an alumina monolith. The reactor was operated with 25 vol..% argon, an ammonia to oxygen ratio of 5 at various temperatures. Ammonia conversions around 80% were achieved with a selectivity to hydrogen of approximately 70%. Autothermal operation was not attained.

TABLE 1
Fe Catalyst, 1.5 slpm, 25 vol. % Ar

| | (NH₃) | Selec- | | Selec- | | Selec- | |
|---|---|---|---|---|---|---|---|
| | Con- | tivity | Yield | tivity | Yield | tivity | Yield |
| Temp | version | to N₂ | of N₂ | to H₂ | of H₂ | to H₂O | of H₂O |
| 769.5 | 0.632 | 1 | 0.632 | 0.608 | 0.385 | 0.392 | 0.248 |
| 769.5 | 0.654 | 1 | 0.654 | 0.608 | 0.395 | 0.396 | 0.259 |
| 801.7 | 0.748 | 1 | 0.748 | 0.662 | 0.496 | 0.338 | 0.253 |
| 869.5 | 0.818 | 1 | 0.818 | 0.713 | 0.583 | 0.287 | 0.235 |
| 931.5 | 0.839 | 1 | 0.839 | 0.721 | 0.605 | 0.279 | 0.234 |
| 905.1 | 0.757 | 1 | 0.757 | 0.715 | 0.541 | 0.285 | 0.216 |

The data of Table 2 below show the results for platinum supported on an alumina monolith. The reactor was operated with an ammonia to oxygen ration of 5 at various temperatures. Ammonia conversions around 60% were achieved with a selectivity to hydrogen ranging from 40% to 60%. Autothermal operation was not attained.

TABLE 2
Pt Catalyst, 1.5 slpm, 25 vol. % Ar

| | (NH₃) | Selec- | | Selec- | | Selec- | |
|---|---|---|---|---|---|---|---|
| | Con- | tivity | Yield | tivity | Yield | tivity | Yield |
| Temp | version | to N₂ | of N₂ | to H₂ | of H₂ | to H₂O | of H₂O |
| 1077.9 | 0.630 | 1 | 0.630 | 0.592 | 0.373 | 0.408 | 0.257 |
| 1052.5 | 0.631 | 1 | 0.631 | 0.571 | 0.361 | 0.429 | 0.271 |
| 1001.1 | 0.612 | 1 | 0.612 | 0.517 | 0.316 | 0.483 | 0.295 |
| 966.4 | 0.492 | 1 | 0.492 | 0.471 | 0.232 | 0.529 | 0.260 |
| 913.9 | 0.497 | 1 | 0.497 | 0.408 | 0.203 | 0.592 | 0.294 |
| 878.4 | 0.448 | 1 | 0.448 | 0.381 | 0.172 | 0.618 | 0.277 |
| 869.5 | 0.513 | 1 | 0.513 | 0.368 | 0.189 | 0.632 | 0.324 |

The data of Table 3 below show the results for platinum supported on a alumina monolith. The reactor was operated autothermally at various ammonia to oxygen ratios. The performance of this reactor is less than the performance of the reactor containing heat input of as in Table 2 above. Nonetheless, the advantage here is that autothermal operation was attained.

TABLE 3
Pt Catalyst, 1.5 slpm, 25 vol. % Ar, No Preheat

| | (NH₃) | Selec- | | Selec- | | Selec- | |
|---|---|---|---|---|---|---|---|
| NH₃/ | Con- | tivity | Yield | tivity | Yield | tivity | Yield |
| O₂ | version | to N₂ | of N₂ | to H₂ | of H₂ | to H₂O | of H₂O |
| 5 | 0.421 | 1 | 0.421 | 0.366 | 0.154 | 0.634 | 0.267 |
| 6 | 0.307 | 1 | 0.307 | 0.260 | 0.080 | 0.740 | 0.227 |
| 7 | 0.238 | 1 | 0.238 | 0.170 | 0.041 | 0.830 | 0.198 |
| 8 | 0.199 | 1 | 0.199 | 0.109 | 0.022 | 0.891 | 0.177 |
| 9 | 0.141 | 1 | 0.141 | 0.054 | 0.008 | 0.946 | 0.134 |

The data of Table 4 below show the results for ruthenium supported on an alumina monolith. The reactor was operated with an ammonia to oxygen ratio of 5 at various temperatures. Ammonia conversions in excess of 95% were achieved with an 80% selectivity to hydrogen.

TABLE 4
Ru Catalyst, 1.5 slpm, 25 vol. % Ar

| | (NH₃) | Selec- | | Selec- | | Selec- | |
|---|---|---|---|---|---|---|---|
| | Con- | tivity | Yield | tivity | Yield | tivity | Yield |
| Temp | version | to N₂ | of N₂ | to H₂ | of H₂ | to H₂O | of H₂O |
| 861 | 0.974 | 1 | 0.974 | 0.791 | 0.770 | 0.209 | 0.204 |
| 824 | 0.961 | 1 | 0.961 | 0.786 | 0.755 | 0.214 | 0.205 |
| 751 | 0.937 | 1 | 0.937 | 0.779 | 0.730 | 0.221 | 0.207 |
| 676 | 0.885 | 1 | 0.885 | 0.760 | 0.672 | 0.240 | 0.213 |
| 627 | 0.820 | 1 | 0.820 | 0.742 | 0.609 | 0.258 | 0.211 |
| 598 | 0.806 | 1 | 0.806 | 0.727 | 0.586 | 0.273 | 0.220 |
| 637 | 0.829 | 1 | 0.829 | 0.746 | 0.619 | 0.254 | 0.210 |
| 704 | 0.909 | 1 | 0.909 | 0.770 | 0.700 | 0.230 | 0.209 |
| 834 | 0.958 | 1 | 0.958 | 0.789 | 0.756 | 0.211 | 0.202 |
| 878 | 0.964 | 1 | 0.964 | 0.793 | 0.764 | 0.207 | 0.200 |

The data of Table 5 below show the results for ruthenium supported on an alumina monolith. The reactor was operated autothermally at various ammonia to oxygen ratios.

TABLE 5
Ru Catalyst, 1.5 slpm, 25 vol. % Ar, No Preheat

| | (NH₃) | Selec- | | Selec- | | Selec- | |
|---|---|---|---|---|---|---|---|
| NH₃/ | Con- | tivity | Yield | tivity | Yield | tivity | Yield |
| O₂ | version | to N₂ | of N₂ | to H₂ | of H₂ | to H₂O | of H₂O |
| 5 | 0.824 | 1 | 0.824 | 0.744 | 0.612 | 0.257 | 0.212 |
| 6 | 0.741 | 1 | 0.741 | 0.709 | 0.525 | 0.291 | 0.216 |
| 7 | 0.598 | 1 | 0.598 | 0.678 | 0.406 | 0.322 | 0.192 |
| 8 | 0.487 | 1 | 0.487 | 0.619 | 0.301 | 0.381 | 0.185 |
| 9 | 0.428 | 1 | 0.428 | 0.560 | 0.240 | 0.440 | 0.188 |

The data of Table 6 below show the results for ruthenium supported on an alumina monolith in which the feed gases have been preheated by 250° C. The reactor was operated autothermally at various ammonia to oxygen ratios and shows improved performance when compared to autothermal operation and no preheat.

TABLE 6
Ru Catalyst, 1.5 slpm, 25 vol. % Ar, Preheat

| | (NH₃) | Selec- | | Selec- | | Selec- | |
|---|---|---|---|---|---|---|---|
| NH₃/ | Con- | tivity | Yield | tivity | Yield | tivity | Yield |
| O₂ | version | to N₂ | of N₂ | to H₂ | of H₂ | to H₂O | of H₂O |
| 5 | 0.911 | 1 | 0.911 | 0.778 | 0.709 | 0.222 | 0.202 |
| 6 | 0.796 | 1 | 0.796 | 0.762 | 0.606 | 0.238 | 0.190 |
| 7 | 0.70 | 1 | 0.695 | 0.754 | 0.524 | 0.246 | 0.171 |
| 8 | 0.61 | 1 | 0.605 | 0.733 | 0.444 | 0.267 | 0.161 |
| 9 | 0.54 | 1 | 0.538 | 0.730 | 0.393 | 0.270 | 0.145 |

The data presented in Table 7 below show the results of the ruthenium catalyst experiments in the coaxial reactor system are shown in FIG. 4 hereof and reveals that preheating the feed gas with the effluent gas stream improves the reactor performance. Also note that lower ammonia to oxygen ratios were examined. When comparing the straight-tube (single pass) and coaxial reactors (two pass) with the ruthenium catalyst at an ammonia to oxygen ratio of 5, a 10% improvement in ammonia conversion is observed with the coaxial reactor. Also, at an ammonia to oxygen ratio of 3, the ammonia conversion is 99% with a hydrogen selectivity of 65%.

TABLE 7
Ru Catalyst Performance in the Coaxial two-pass Quartz Reactor Using
a Monolithic Catalyst Bed of FIG. 4 with Autothermal Operation

| | (NH₃) | Selec- | | Selec- | | Selec- | |
|---|---|---|---|---|---|---|---|
| NH_{3/} | Con- | tivity | Yield | tivity | Yield | tivity | Yield |
| O₂ | version | to N₂ | of N₂ | to H₂ | of H₂ | to H₂O | of H₂O |
| 3 | 0.989 | 1 | 0.989 | 0.641 | 0.634 | 0.359 | 0.355 |
| 4 | 0.976 | 1 | 0.976 | 0.725 | 0.707 | 0.275 | 0.268 |
| 5 | 0.926 | 1 | 0.926 | 0.758 | 0.702 | 0.242 | 0.224 |
| 6 | 0.826 | 1 | 0.826 | 0.735 | 0.607 | 0.265 | 0.219 |
| 7 | 0.754 | 1 | 0.754 | 0.718 | 0.541 | 0.282 | 0.213 |
| 8 | 0.645 | 1 | 0.645 | 0.689 | 0.445 | 0.311 | 0.201 |
| 9 | 0.596 | 1 | 0.596 | 0.654 | 0.390 | 0.346 | 0.206 |

The data presented in Table 8 below show the results of experiments using a nickel woven mesh as the catalyst bed in the coaxial reactor system of FIG. 4 hereof and also reveals that preheating the feed gas with the effluent gas stream improves the reactor performance

TABLE 8
Ni Woven Mesh Catalyst Performance in the Coaxial two-pass Quartz
Reactor of FIG. 4 with Autothermal Operation

| | (NH₃) | Selec- | | Selec- | | Selec- | |
|---|---|---|---|---|---|---|---|
| NH_{3/} | Con- | tivity | Yield | tivity | Yield | tivity | Yield |
| O₂ | version | to N₂ | of N₂ | to H₂ | of H₂ | to H₂O | of H₂O |
| 3 | 0.986 | 1 | 0.986 | 0.590 | 0.582 | 0.410 | 0.404 |
| 4 | 0.975 | 1 | 0.975 | 0.684 | 0.666 | 0.316 | 0.309 |
| 5 | 0.939 | 1 | 0.939 | 0.702 | 0.659 | 0.298 | 0.280 |
| 6 | 0.865 | 1 | 0.865 | 0.692 | 0.599 | 0.308 | 0.266 |
| 7 | 0.742 | 1 | 0.742 | 0.661 | 0.491 | 0.339 | 0.251 |
| 8 | 0.663 | 1 | 0.663 | 0.637 | 0.423 | 0.363 | 0.240 |
| 9 | 0.598 | 1 | 0.598 | 0.590 | 0.352 | 0.410 | 0.245 |

1. An autothermal process for the decomposition of ammonia, which process comprises:
feeding a mixture of ammonia and an oxygen-containing gas into a reaction zone where it is contacted with an ammonia decomposition catalyst at effective conditions to cause the ammonia to decompose into nitrogen and hydrogen by an endothermic reaction, wherein a portion of the hydrogen thus produced is combusted in said reaction zone by an exothermic reaction that produces an effective amount of heat to maintain the ammonia decomposition reaction.

2. The autothermal process of claim 1 wherein the oxygen-containing gas is air.

3. The autothermal process of claim 1 wherein the decomposition catalyst contains at least one metal selected from the groups consisting of IIIA, IVA, VA, VIA, VIIA, VIIIA, IB, and IIB of the Periodic Table of the Elements

4. The autothermal process of claim 3 wherein the decomposition catalyst contains at least one metal selected from the Groups VIA, VIIA, and VIIIA of the Periodic Table of the Elements.

5. The autothermal process of claim 4 wherein the decomposition catalyst contains at least one metal selected from the group consisting of Fe, Ni, Co, Cr, Mn, Pt, Pd, and Ru.

6. The autothermal process of claim 1 wherein the decomposition catalyst is supported on a support selected from monoliths, fiber mats, and refractory particles.

7. The autothermal process of claim 6 wherein the support is comprised of a material selected from the group consisting of carbon and a metal oxide.

8. The autothermal process of claim 7 wherein the support is comprised of a material selected from the group consisting of alumina, silica, silca-alumina, titania, magnesia, and aluminum metasilicates.

9. The autothermal process of claim 8 wherein the support is comprised of alumina in the form of a monolith.

10. The autothermal process of claim 9 wherein the monolith is in the form of a honeycomb structure comprised of a plurality of finely divided gas flow passages extending there-through.

11. The autothermal process of claim 1 wherein the reactor in which ammonia decomposition and hydrogen combustion take place is a thermal integration reactor wherein a hot effluent gas is produced which transfers heat to incoming feed comprised of ammonia and an oxygen-containing gas.

12. A method for operating a hydrogen fuel cell which method comprising:
passing a mixture of ammonia and an oxygen-containing gas to a reaction zone containing an ammonia decomposition catalyst at effective conditions under which said ammonia undergoes decomposition to nitrogen and hydrogen and wherein a first portion of said hydrogen is combusted in said reaction zone to produce an effective amount of heat to maintain the ammonia decomposition reaction;
passing a second portion of hydrogen to said hydrogen fuel cell; and
reacting said hydrogen in said hydrogen fuel cell to produce electric current.

13. The method of claim 12 wherein the oxygen-containing gas is air.

14. The method of claim 12 wherein a third portion of hydrogen is passed to a hydrogen storage tank.

15. The method of claim 12 wherein said wherein the decomposition catalyst contains at least one metal selected from the groups consisting of IIIA, IVA, VA, VIA, VIIA, VIIIA, IB, and IIB of the Periodic Table of the Elements.

16. The method of claim 15 wherein the decomposition catalyst contains at least one metal selected from the group consisting of Fe, Ni, Co, Cr, Mn, Pt, Pd, and Ru.

17. The method of claim 12 wherein said fuel cell is associated with a transportation vehicle by supplying power to said transportation vehicle.

18. The method of claim 12 wherein the reactor in which ammonia decomposition and hydrogen combustion take place is a thermal integration reactor wherein a hot effluent gas is produced which transfers heat to incoming feed comprised of ammonia and an oxygen-containing gas.

19. A method for operating an internal combustion engine transportation vehicle having an ammonia storage vessel and an ammonia decomposition reactor, said method comprising:
passing a mixture of ammonia and air from said ammonia storage vessel into said ammonia decomposition reactor containing an ammonia decomposition catalyst at effective conditions that will cause the ammonia to decompose to nitrogen and hydrogen and wherein a first portion of said hydrogen is combusted in said reaction zone to produce an effective amount of heat to maintain the ammonia decomposition reaction;
passing a second portion of hydrogen, which is a product of said ammonia decomposition reactor as fuel to the internal combustion engine.

19. The autothermal process of claim 18 wherein the decomposition catalyst contains at least one metal selected from the groups consisting of IIIA, IVA, VA, VIA, VIIA, VIIIA, IB, and IIB of the Periodic Table of the Elements

20. The autothermal process of claim 19 wherein the decomposition catalyst contains at least one metal selected from the Groups VIA, VIIA, and VIIIA of the Periodic Table of the Elements.

21. The autothermal process of claim 20 wherein the decomposition catalyst contains at least one metal selected from the group consisting of Fe, Ni, Co, Cr, Mn, Pt, Pd, and Ru.

22. The autothermal process of claim 19 wherein the decomposition catalyst is supported on a support selected from monoliths, fiber mats, and refractory particles.

23. The autothermal process of claim 22 wherein the support is comprised of a material selected from the group consisting of carbon and a metal oxide.

24. The autothermal process of claim 23 wherein the support is comprised of a material selected from the group consisting of alumina, silica, silca-alumina, titania, magnesia, and aluminum metasilicates.

25. The autothermal process of claim 24 wherein the support is comprised of alumina in the form of a monolith.

26. The autothermal process of claim 25 wherein the monolith is in the form of a honeycomb structure comprised of a plurality of finely divided gas flow passages extending there-through.
